(19) United States
(12) Patent Application Publication
(10) Pub. No.: US 2003/0163939 A1
(43) Pub. Date: Sep. 4, 2003

(54) Temporary/permanent vehicular bumper guard/advertising specialty

(76) Inventor: Dennis Peter Bargowski, Wyandotte, MI (US)

Correspondence Address: Dennis Peter Bargowski, 217 Superior Blvd., Wyandotte, MI, 48192, US

(21) Appl. No.: 10/360,366

(22) Filed: Feb. 8, 2003

Related U.S. Application Data
(60) Provisional application No. 60/361,487, filed on Mar. 4, 2002.

(51) Int. Cl. G09F 7/12

(52) U.S. Cl. 40/594

(57) ABSTRACT

Bumper Guard that can be affixed with just an adhesive and can be used for/in advertising as an advertising specialty piece that will be mounted to a bumper to protect the bumper.

### BACKGROUND OF THE INVENTION

1. Field of the Invention

This new invention relates to bumper guards and advertising, and pertains particularly to a new bumper guard for protecting a vehicular bumper from damage that can be used also as an advertising promotion piece. This new invention also relates to artistic designer creations, artistic designer shapes, and symbols that also takes on the use of a bumper guard for a vehicle.

2. Description of the Prior Art

The use of bumper guards is known in the prior art. More specifically, bumper guards heretofore devised and utilized are known to consist basically of familiar, expected and obvious structural configurations.

This application lays reference priority to U.S. Provisional Pat. No. 60/361487.

Known prior art includes U.S. Pat. No. 6,283,518 U.S. Pat. No. 5,618,073; U.S. Pat. No. 4,690,446- U.S. Pat. No. 2,758,866; U.S. Pat. No. 4,884,824; U.S. Pat. No. 4,726,614; and U.S. Pat. Des. 378,909.

In these respects, the bumper guard according to the present invention substantially departs from the conventional concepts and designs of the prior art, and is uniquely new, simpler, and usefully different, and not obvious, since it has never been done before in all the years aforementioned bumper guards have been on the market in its conversion from just protecting a vehicular bumper from damage to being designed to have more than just that one purpose as the aforementioned bumper guards have always done.

Example: The present invention being designed as a new advertising specialty item, artistic designer creation, etc. as mention in the claims while also having the purpose of protecting a vehicular bumper from damage and in so doing provides a new product that is a uniquely different apparatus and developed and designed for more than just one purpose (the purpose of just protecting a vehicular bumper from damage) while also having other new, useful, and susceptibility of desirable economic benefits to the consumer.

The present invention has the susceptibility of a lower cost of manufacture, ease of installation, low or no cost of installation, quickness of installation, simplifying design, susceptibility of a lower cost to the buying public.

### SUMMARY OF THE INVENTION

In view of the known types of bumper guards now present in the prior art and their foregoing disadvantages inherent, the present invention provides a new bumper guard wherein the same can be utilized for protecting a vehicular bumper from damage while also having other unique differences.

The purpose of the present invention which will be described subsequently in more detail, is to provide a new bumper guard apparatus and method, which has many of the advantages of the bumper guards mentioned heretofore and more importantly novel and unique features that result in a new bumper guard which is not rendered obvious, anticipated, suggested, or even implied by any of the prior art bumper guards, either by themselves or in any combination thereof.

It is an object of this invention to provide new bumper guards which are susceptible to a low cost manufacture with regard to both materials and labor, and which is then accordingly susceptible to low prices of sale to the general consumer public, making such bumper guards economically sound to the general buying public.

It is further an object of this present invention to provide a new bumper guard to protect a vehicular bumper from damage. It is further another object of this invention to provide a bumper guard with a very low cost or a no cost installation. It is further another object of this invention to provide for a bumper guard that has quick installation. It is further another object of this invention to provide for a bumper guard that has an easy installation. Also, it is further another object of this invention to provide new bumper guards, which may be easily and efficiently manufactured and marketed.

It is further an object of this present invention to provide a new bumper guard that can have added purposes along with protecting a vehicular bumper from damage (Example: Advertising, art expression, etc.).

It is further an object of this present invention to provide a new bumper guard that is unique in that it is a temporary or permanent bumper guard system for use on a bumper of a vehicle, that can be affixed with just an adhesive and does not need the use of magnets.

It is further an object of the present invention to provide a new bumper guard for a vehicle that is unique in that it will be used as an advertising specialty under circumstances, and any of such suitable modifications and equivalents that may be resorted to.

It is further an object of the present invention to provide a new bumper guard for a vehicle that is unique in that they will be artistic designer creations, artistic designer shapes, or symbols, names, or numbers under circumstances, and any of such suitable modifications and equivalents that may be resorted to.

### DESCRIPTION

To attain this, the present invention is simpler, more economically feasible, and can be used as either a temporary or permanent bumper guard system for use on a bumper of a vehicle, that can be easily and quickly affixed by a consumer with just an adhesive (the adhesive most likely will be in the form of an adhesive tape or adhesive composite attached or combined with a cushion of at least 3/16 inch in thickness) and does not need the use of magnets like many other bumper guard systems, therefore costs of the magnets would be saved making this product more efficient and economical to make, and the ease of affixing the bumper guards will save money for installation making the present invention more desirable than other bumper guards mentioned heretofore.

This invention is unique in another way in that a bumper guard for a vehicle will now be designed, shaped, and used to advertise, and be used as an advertising specialty, and any of such suitable modifications and equivalents that may be resorted to. Also, this invention is also unique in another way in that a bumper guard for a vehicle will now be designed, or shaped as artistic designer creations, artistic designer shapes, or symbols, or names, or numbers, or combination thereof, and any of such suitable modifications and equivalents that may be resorted to.

Being used as an advertising, or marketing tool (advertising specialty) will make the manufacture of these new bumper guards susceptible of a very low cost manufacture with regard to both materials and labor because companies will be susceptible to producing these new bumper guards more competitively, and the consuming public therefore should benefit. An object is that by having advertisers trying to advertise with this product that consumers may have a new bumper guard for protecting a vehicular bumper from damage (susceptible to saving consumers great cost in repairs) at a greatly reduced cost to the consumer (susceptible to saving consumers great costs in purchasing), if any cost to the consumer since advertisers may pick up much of the costs.

There has thus been outlined, rather broadly, the more important features of the invention in order that the detailed description thereof that follows may be better understood. Also, in order that the present contribution to the art may be better appreciated. There are also additional features of the invention that will be described hereinafter, which will form the subject matter of the claims appended hereto.

Before explaining at least one embodiment of the invention in detail, in this respect, it is to be understood that the invention is not limited in its application, or use, to the details of construction and to the arrangements of the components set forth in the following description or illustrated in the drawings. This invention is capable of other embodiments and of being practiced and carried out in other various ways. Also, it should be understood that the terminology and phraseology employed herein are for the purpose of a description and should not be taken or regarded as limiting.

Those that are skilled in the art as such, will be able to appreciate that the conception, upon which this disclosure is based, may be readily utilized as a basis for the designing of other such structures, and methods, and systems, or combination thereof for carrying out the several purposes of the present invention. It is therefore important, that the claims be regarded as including such equivalent constructions, in that they do not depart from the spirit and scope of the present invention.

The purpose of the foregoing abstract is to enable the United States Patent and Trademark Office and the general public, and especially the engineers, scientists, and practitioners in the art who are not familiar with patent phraseology, or legal terms, to determine expeditiously from a cursory inspection the nature and essence of the disclosure of the application.

This abstract is neither intended to define the invention of the application, which is measured by the claims, nor is it intended to be limiting in any way as to the scope of the invention.

Therefore it is an object of this present invention to provide a new bumper guard apparatus, and method which has advantages of the bumper guards mentioned heretofore and uniquely different novel features, methods, and use, that results in new bumper guards which are not anticipated, suggested, implied, or rendered obvious by any of the prior art bumper guards, either alone or in any combination thereof.

It is an object of this invention to provide new bumper guards which are susceptible to a low cost manufacture with regard to both materials and labor, and which is then accordingly susceptible to low prices of sale to the general consumer public, making such bumper guards economically sound to the general buying public.

It is further an object of this present invention to provide a new bumper guard to protect a vehicular bumper from damage. It is further another object of this invention to provide a bumper guard with a very low cost or a no cost installation. It is further another object of this invention to provide for a bumper guard that has quick installation. It is further another object of this invention to provide for a bumper guard that has an easy installation. Also, it is further another object of this invention to provide new bumper guards, which may be easily and efficiently manufactured and marketed.

It is further an object of this present invention to provide a new bumper guard that can have added purposes along with protecting a vehicular bumper from damage (Example: Advertising, art expression, etc.).

These along with the various other features of novelty and uniqueness which characterizes this invention, are pointed out with particularity in the claims annexed to, and forming a portion of this disclosure. For added understanding of this invention, specific objects attained by its uses, its advantages, and methods for uses, reference should be made to the accompanying drawings and additional text.

### BRIEF DESCRIPTION OF THE DRAWINGS

This invention will be better understood, the objects of the invention, its uses, methods for use, and objects will be better understood, other than those set forth above will become apparent when consideration is given to the following additional text, along with the description with the annexed drawings wherein:

FIG. 1 A Side view of a new bumper guard cushion according to the present invention (cushion will be at least 3/16 inch in thickness).

FIG. 2 A Side view of a new bumper guard adhesive placement

FIG. 3 An Example front view for a new bumper guard

FIG. 4. An Example front view for a new bumper guard

FIG. 5 An Example front view for a new bumper guard

FIG. 6 An Example front view for a new bumper guard

FIG. 7 An Example front view for a new bumper guard

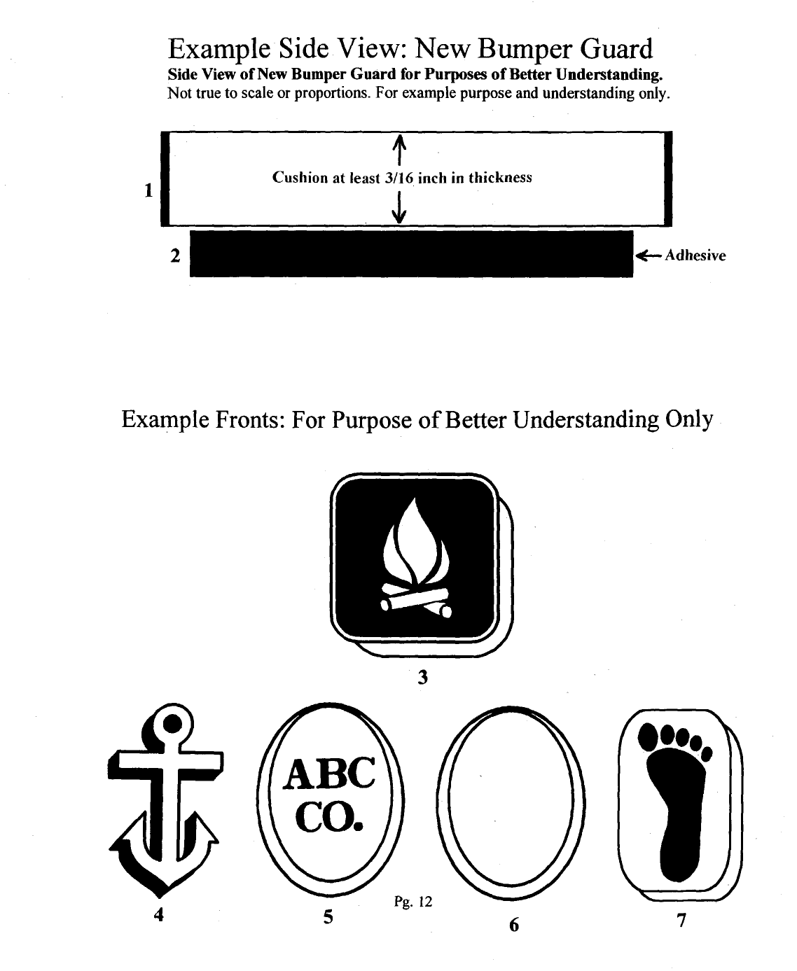

With reference now to the drawings, and in particular to FIG. 1 through FIG. 7 thereof, is a new bumper guard embodying the general principles and concepts of the present invention. As for a further discussion of the manner of usage and operation of the present invention, the same should be apparent from the foregoing description and text description above. Accordingly, no further discussion relating to the manner of usage and operation will be provided.

In addition, with respect to the above descriptions then, all equivalent relationships to those illustrated in the drawings and described in the specification are intended to be encompassed by the present invention, and it is to be realized that the optimum dimensional relationships for the parts of the invention, to include variations in materials, size, form, function and manner of operation, assembly and use, and shape are deemed readily apparent and obvious to one skilled in the art. Thus, the foregoing is to be considered as only illustrative of the principles of the present invention. Falling within the scope of the invention it is further to be understood that since modifications and changes will occur to those skilled in the art, it is not desired to limit the invention to the exact construction and operation shown and described, and accordingly, all of the suitable modifications and the equivalents that may be resorted to.

I claim:

1. A temporary or permanent bumper guard system for use on a bumper of a vehicle, that can be affixed with just an adhesive and does not need the use of magnets.

2. Right to a bumper guard for a vehicle that is unique in that it will be used as an advertising specialty, and any of such suitable modifications and equivalents that may be resorted to.

3. Right to a bumper guard for a vehicle that is unique in that they will be artistic designer creations, artistic designer shapes, or symbols, names, or numbers, and any of such suitable modifications and equivalents that may be resorted to.
